(19) United States
(12) Patent Application Publication
(10) Pub. No.: US 2024/0097460 A1
(43) Pub. Date: Mar. 21, 2024

(54) Methods, Apparatuses, and Systems That Include Secondary Electrochemical Unit Anomaly Detection and/or Overcharge Prevention Based On Reverse Coulombic Efficiency

(71) Applicant: SES Holdings Pte. Ltd., Singapore (SG)

(72) Inventors: Weijie Mai, Medford, MA (US); Hong Gan, Woburn, MA (US)

(21) Appl. No.: 18/269,112

(22) PCT Filed: Nov. 17, 2021
(86) PCT No.: PCT/IB2021/060657

§ 371 Date: Jun. 22, 2023

Related U.S. Application Data
(60) Provisional application No. 63/128,918, filed on Dec. 22, 2020.

(51) Int. Cl. H02J 7/00; H01M 10/42; H01M 10/44; H01M 10/48

(52) U.S. Cl. CPC H02J 7/00302; H01M 10/425; H01M 10/44; H01M 10/48; H02J 7/0048; H02J 7/005; H02J 7/00716; H01M 2010/4271

(57) ABSTRACT

Methods of detecting anomalies in and/or overcharge protection for secondary (rechargeable) electrochemical units, such as secondary cells and multicell secondary batteries. In some embodiments, the methods are based on a health measure referred to as “reverse coulombic efficiency” (RCE), which is based on a principle that the maximum amount of charge added to a secondary electrochemical unit during recharging should equal a net amount of charge discharged from the secondary electrochemical unit since a most recent fully charged state. An RCE-based health measure can be used to predict anomalies in secondary electrochemical units that can lead, for example, to overheating, explosion, and underperformance, among other things. Apparatuses and systems for implementing RCE-based anomaly detection and/or overcharge protection are also disclosed.

### RELATED APPLICATION DATA

This application claims the benefit of priority of U.S. Provisional Patent Application Ser. No. 63/128,918, filed Dec. 22, 2020, and titled “Methods, Apparatuses, and Systems That Include Battery or Electrochemical Cell Overcharge Detection and Prevention Based on Reverse Coulombic Efficiency”, which is incorporated by reference herein in its entirety.

### FIELD OF THE INVENTION

The present invention generally relates to the field of battery management. In particular, the present invention is directed to methods, apparatuses, and systems that include secondary electrochemical unit anomaly detection and/or overcharge prevention based on reverse coulombic efficiency.

### BACKGROUND

Rechargeable, or secondary, batteries that use lithium metal anodes are prone to overcharge due to lithium dendrite/mossy lithium formation/growth during repeated lithium plating and stripping, which can lead to cell explosion if not properly handled. Traditionally, cell cycling is stopped when a cell is overcharged or shorted during discharge under normal cycling conditions to prevent cell explosion. However, these methods can only detect severe overcharge and internal short scenarios, which may be too late to prevent catastrophic consequences.

### SUMMARY

In one implementation, the present disclosure is directed to a method of managing a secondary electrochemical unit. The method includes at the beginning of a current charging cycle, causing charging circuitry to add charge to the secondary electrochemical unit; automatically determining a cumulative charge added by the charging circuit during the current charging cycle; automatically evaluating whether or not the cumulative charge added causes a reverse-coulombic-efficiency (RCE)-based health measure to violate an RCE-based limit; and when the RCE-based health measure violates the RCE-based limit, automatically causing a physical component to take a predetermined action that is a function of the RCE-based limit.

In another implementation, the present disclosure is directed to an apparatus or system, including memory containing machine-executable instructions for performing a method of managing a secondary electrochemical unit; and one or more processors in operative communication with the memory, wherein the one or more processors are configured to execute the computer-executable instructions so that the apparatus or system performs the method. The method includes at the beginning of a current charging cycle, causing charging circuitry to add charge to the secondary electrochemical unit; automatically determining a cumulative charge added by the charging circuit during the current charging cycle; automatically evaluating whether or not the cumulative charge added causes a reverse-coulombic-efficiency (RCE)-based health measure to violate an RCE-based limit; and when the RCE-based health measure violates the RCE-based limit, automatically causing a physical component to take a predetermined action that is a function of the RCE-based limit.

In yet another implementation, the present disclosure is directed to a computer-readable storage medium containing machine-executable instructions for performing a method of managing a secondary electrochemical unit. The method includes at the beginning of a current charging cycle, causing charging circuitry to add charge to the secondary electrochemical unit; automatically determining a cumulative charge added by the charging circuit during the current charging cycle; automatically evaluating whether or not the cumulative charge added causes a reverse-coulombic-efficiency (RCE)-based health measure to violate an RCE-based limit; and when the RCE-based health measure violates the RCE-based limit, automatically causing a physical component to take a predetermined action that is a function of the RCE-based limit.

### BRIEF DESCRIPTION OF THE DRAWINGS

For the purpose of illustration, the drawings show aspects of one or more embodiments of the present disclosure. However, it should be understood that the present disclosure is not limited to the precise arrangements and instrumentalities shown in the drawings, wherein:

FIG. 1A is a graph of frequency of occurrence versus values of end-of-charge “reverse coulombic efficiency” (RCE) health index across all cycles in an example data set for 121 secondary cells that included good and bad cells;

FIG. 1B is a graph of recall and precision percentage versus deviation of end-of-charge RCE from 100% (full charge) for data of FIG. 1A, illustrating an example selection of a normality window for end-of-charge RCE values;

FIG. 2 is a graph of state-of-charge (SOC) over a number of charge/discharge cycles and time for an example cell that is not fully recharged after every discharge cycle, illustrating the measure of net discharge;

FIG. 3A is a graph of end-of-charge RCE health index versus cycle number for a first test cell that experienced an anomaly at around 135 cycles as determined using a normality range of 100%+2% for the RCE health index, wherein the anomaly is of a sort in which the cell, upon recharging, accepts an amount of charge exceeding a net discharged amount of charge discharged since the most recent full charge state;

FIG. 3B is a graph of charge capacity versus cycle number corresponding to the data of FIG. 3A;

FIG. 4A is a graph of end-of-charge RCE health index versus cycle number for a second test cell that experienced an anomaly just after 300 cycles as determined using a normality range of 100%+2% for the RCE, wherein the anomaly is of a sort in which the cell, upon recharging, accepts an amount of charge exceeding a net discharged amount of charge discharged since the most recent full charge state;

FIG. 4B is a graph of charge capacity versus cycle number corresponding to the data of FIG. 4A;

FIG. 5 is a flow diagram illustrating an example RCE-based method that can be performed during the charging of a secondary electrochemical unit;

FIG. 6A is a graph of each of charge capacity and capacity retention versus cycle number for a third test cell tested to illustrate application of a difference-in-moving-averages (DMA) analysis of end-of-charge RCE values;

FIG. 6B is a graph of end-of-charge RCE values, DMA values, and related DMA data versus cycle number for the secondary test cell of FIG. 6A, illustrating an example of the ability of DMA analysis to detect anomalies earlier than strict RCE analysis;

FIG. 6C is a graph of frequency of occurrence versus DMA values over many test cycles performed on 121 test cells, illustrating the distribution of DMA values used to determine a DMA value for the RCE-based limit;

FIG. 7A is a graph of each of charge capacity and capacity retention versus cycle number for a fourth test cell tested to illustrate another application of DMA analysis of end-of-charge RCE values;

FIG. 7B is a graph of end-of-charge RCE values, DMA values, and related DMA data versus cycle number for the secondary test cell of FIG. 7A, illustrating another example of the ability of DMA analysis to detect anomalies earlier than strict RCE analysis;

FIG. 8 is a graph of RCE health index versus cycle number, illustrating an example in which a test electrochemical cell experienced an oscillation in RCE values in relatively early charge cycles after which the RCE health index values stabilized at around 100% before greatly exceeding 102% in later cycles;

FIG. 9 is a graph of RCE health index versus cycle numbers, illustrating an example scenario in which more than one RCE-based limits can be used to heal an electrochemical unit;

FIG. 10 is a flow diagram illustrating an example method of charging a secondary electrochemical unit that includes a healing protocol;

FIG. 11 is a high-level block diagram illustrating various systems implementing at least one RCE-based methodology of the present disclosure; and

FIG. 12 is a high-level block diagram illustrating an example computing system implementing any one or more RCE-based methodologies of the present disclosure.

### DETAILED DESCRIPTION

In this disclosure, a new, but simple, health index is set forth that can detect anomalies in secondary electrochemical units (e.g., secondary electrochemical cells and secondary electrochemical batteries composed of one or more secondary electrochemical cells) at an early stage, and thus can be used, among other things, to prevent explosions multiple cycles before it would otherwise happen. It is noted that while the present disclosure is directed to secondary electrochemical units generally, the term “cell” is used for convenience in the below description. It is also noted that this new health index, while particularly useful for active-metal secondary electrochemical units that have active-metal anodes that tend to develop mossy surface and dendrites during cycling, is applicable to other types of secondary electrochemical units, such as lithium-ion cells and batteries, lead-acid cells and batteries, nickel cadmium cells and batteries, and nickel metal hydride cells and batteries, among others. Examples of active-metal secondary electrochemical units include such units based on metals such as, but are not limited to, lithium, sodium, potassium, and magnesium, among others, and alloys thereof. For the sake of convenience, lithium-metal secondary electrochemical cells are used as examples herein because of their present relative prominence in current research and commercialization efforts, but the application of the techniques and methodologies disclosed herein are not so limited.

The new health index of the present disclosure relies on a new definition of “overcharge.” The traditional definition of “overcharge” is based on a cell's nominal capacity, implying that the cell cannot be charged to a capacity higher than it originally could contain as a new, or fresh, cell. This definition ignores the fact that a cell's capacity degrades as the cell ages. As a result, the traditional definition will underestimate the severity of overcharge and thus can fail to stop charging in time.

A parameter typically used to detect cell internal shorting is coulombic efficiency (CE), which is the ratio between discharge capacity and charge capacity in the same cycle. In the context of lithium-metal cells or other cells utilizing active-metal anodes in which the active metal can experience mossy and/or dendritic plating during charging, a “hard short” is caused by a severe dendrite growth from the anode to the cathode that leads to immediate failure of the cell, such as explosion. A “soft short,” on the other hand, is less severe and may disappear in a process known as “healing.” However, a soft short could alternatively further develop into a hard short and lead to catastrophic failure. A soft short is under the condition that a conductive pathway between cathode and anode within the cell stack formed due to dendrite growth through the separator that has only a small contact area with high electric resistance. Under such condition, only a small amount of current can pass through it, leading to relatively low heat generation per unit time. In this condition, the generated heat due to the short circuit can dissipate fast. If a soft-shorted cell keeps cycling, the internal short contact area will enlarge due to the further dendrite growth, and the electric resistance at the short spot will reduce. The current flow through the short spot will increase to a level wherein a large amount of heat generated per unit time cannot be dissipated fast enough, leading to thermal run-away reactions that can cause the cell to explode. By detecting a soft short early and stopping the cell cycling, formation of a hard short condition can be prevented, thus preventing cell explosion.

When cells have an internal short (soft short), either the charge added during a charging cycle is larger than the expected capacity or the discharge capacity is lower than the expected capacity due to capacity lost caused by the internal short not recorded by the external circuit. Compounding the problem, CE is not only influenced by internal shorting, but it is also impacted by environmental conditions, such as temperature, making an accurate cell anomaly identification more difficult. In addition, the value of CE is meaningful only when a cell is fully discharged, which limits its application to lab testing conditions.

To address these problems, this disclosure presents the new health index referred to herein and in the appended claims as “reverse coulombic efficiency” (RCE), that forms a basis for, among other things, detecting cell overcharge in secondary electrochemical units, such as lithium-metal battery (LMB) cells, among many others as noted above. The RCE health index is based on the physical understanding that when a cell is discharged and healthy, it cannot be recharged to a capacity higher than what has been discharged from it. In this way, cell overcharge is defined based on the allowable capacity of a temporally current cycle instead of the nominal capacity of a fresh cell, i.e., a cell that has not yet been cycled. Using the RCE health index, capacity fade due to cathode degradation will be corrected—for automatically when the overcharge capacity is calculated. Thus, the capacity used to judge overcharge is not a constant.

Using LMB cells as an example, typically an LMB cell is considered fully-charged after a complete constant current/constant voltage (CC/CV) charging step. The charge C-rate (or current) in the CC step varies, but the CV step typically involves low C-rate cut off, such as C/10 or C/20 as two examples. Thus, the cell state of charge (SOC), or degree of delithiation of the cathode (e.g., a lithium metal oxide (LMO) cathode in an example LMB cell), at such low C-rate charge current cutoffs is less sensitive to temperature variation. For the n^{th} charge-discharge cycle, the full-charge capacity of a CC/CV step is denoted as C_{ch,n}. After the cell is fully charged in the n^{th} cycle, it can be discharged in the n^{th} cycle to any voltage above the lower cut-off voltage. For the same cycle, the discharge capacity is denoted as C_{dis,n}. The coulombic efficiency (CE) is defined by C_{dis,n}/C_{ch,n}><100 if the cell is fully discharged, which describes the charge efficiency of the n^{th} cycle by which electrons are transferred in batteries. While CE is traditionally used to detect cell internal shorting, it is very sensitive to variations of test environment and conditions, such as temperature, state of discharge, and discharge rate, making it a bad/noisy health index. After discharge, the cell can then be fully charged again using CC-CV, the charge capacity of which is denoted as C_{ch,n+1}.

The new RCE health index is defined as:

$$R C E = 100 \times \frac{{C}_{ch , n + 1}}{{C}_{dis , n}} \qquad ( 1 )$$

C_{dis,n} is the amount of charge that has been discharged under any conditions from a fully charged cell, while C_{ch,n+1} is the amount of charge that needs to be added to the cell to charge it back to a fully-charged state. If the cell is normal, or healthy, then the ratio between the two, expressed as a percentage (i.e., the RCE), should be close to 100% when the cell is fully charged independent of the environment and discharge-condition variations. An RCE higher than 100% suggests that the cell is being charged to a capacity higher than required to fully charge it, i.e., that the cell is being overcharged. This indicates that the cell might be internally shorted. An RCE at the end of charge significantly lower than 100% suggests that the cell is otherwise damaged and cannot be fully charged. For example, tab breakage, electrode detachment, and/or electrolyte leakage, among other anomalies, could occur during the charge/discharge process due to external mechanical forces and/or internal gassing, which would increase cell impedance and thus hinder fully charging the cell. This, while not necessarily leading to catastrophic failure such as explosion, can render the cell unable to meet its service requirements, and, therefore, the cell could be identified as having an anomaly. It is noted that as used herein the phrase “at the end of charge” means that the charging has reached a conclusion and the cell has reached a 100% SOC, such as may be determined by monitoring a charging voltage and/or charging current during normal charging. Similarly, the term “end-of-charge” RCE is used herein to denote that the value of RCE is the value at the end of charge, i.e., at 100% SOC as determined by the charging protocol at issue.

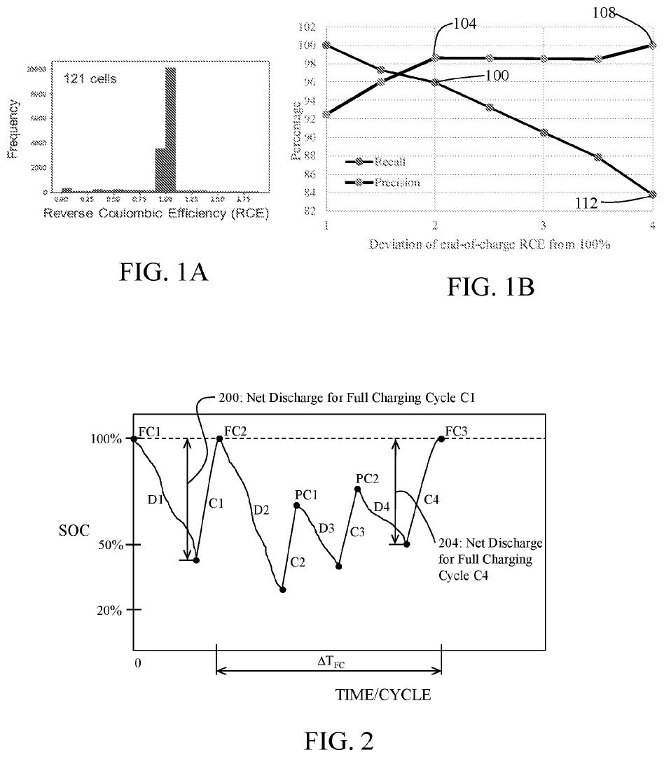

FIG. 1A shows a distribution of end-of-charge RCE values of all cycles in an example data set for a test set of 121 secondary electrochemical cells that included both good and bad cells. The distribution shows that the end-of-charge RCE values in the example data set are highly concentrated around 100%. The normality range of the end-of-charge RCE values in this dataset was determined—using statistical analysis—to be 100%±2%, with which most anomalous cells (e.g., overcharged/undercharged/exploded) in the test set could be detected with high precision, with very few normal (non-anomalous) cells being mislabeled as anomalous. FIG. 1B illustrates an example technique that can be used in determining upper and lower bounds of an RCE normality window.

Referring to FIG. 1B, in this example, two metrics, namely, recall and precision, are used. Recall is the percentage of true anomalous cells detected by the model (recall=100*(detected true anomalous cells/total true anomalous cells)), and precision is the percentage of detected true anomalous cells in all of the detected anomalous cells (precision=100*(detected true anomalous cells/total detected anomalous cells)). These metrics are well known in the art. Using a narrow RCE normality window, the model can detect more anomalous cells but could risk mislabeling some normal cells as anomalous (lower precision). Using a broader RCE normality window, the model only detects anomalous cells that are highly anomalous, so the precision is high. However, it can potentially miss a portion of truly anomalous cells. In this example, using a deviation from 100% (fully recharged) of 2 percentage points as the basis for the RCE normality window (i.e., an RCE value in the range of 98% to 102% is normal), FIG. 1B shows that the model can detect 96% of anomalous cells (recall; datapoint 100) with a precision of 98.6% (datapoint 104). With a precision of 98.6%, this means that out of 100 cells that the model predicts as being anomalous, on average 1.4 of these cells are actually normal. As can be seen in FIG. 2B from datapoint 108, 100% precision (i.e., no normal cells mislabeled as being anomalous) can be achieved in this dataset by increasing the normality range to 96% to 104% (100%−/+4%). However, this comes at the price of a reduction in the percentage of anomalous cells being detected to about 84% (datapoint 112). Depending on the seriousness of a missed anomaly, the thresholds used in practice should be adjusted accordingly.

A normality range can be applied to real-life scenarios outside a testing phase, such as routine recharging in fielded secondary electrochemical units, as the RCE health index has a physical ground and is not sensitive to cell chemistry, cell design, and usage (discharge) conditions. For applications in which cell usage can consist of multiple partial-charge/discharge steps, such as with electric vehicles (EVs) wherein periodic regenerative braking can cause numerous partial-charging cycles, among many other applications, the net charge discharged from a previous full charge should be used as the C_{dis,n} to calculate the RCE of the current CC-CV charging step. This is illustrated in FIG. 2.

Referring to FIG. 2, this figure illustrates the SOC of an example healthy secondary electrochemical cell over a number of charging/discharge cycles and over a period of time. FIG. 2 illustrates both a situation in which the cell is fully recharged (FC2) in a single charging cycle (C1) after a single discharge cycle (D1) that started with a fully charged state (FC1) and a situation in which the cell is only partially recharged between some of the discharge cycles. Specifically in this example, the situation wherein the cell is only partially charged between discharge cycles is composed of two partial charging cycles, PC1 and PC2, and a total of three discharge cycles, D2 through D4, occurring between the current fully charged state FC3 and the most recent (relative to the current fully charged state FC3) fully charged state FC2. In the first situation noted above, the net discharged amount is simply the actual amount of discharged charge, D1, discharged between the contiguous fully charged states FC1 and FC2. This is represented in FIG. 2 at 200. However, in the second situation, the net discharged amount is equal to the sum of all of the discharged charge amounts occurring between fully charged state FC2 and fully charged state FC3, i.e., the sum of D2 through D4, minus the total amount of charge added back into the cell prior to the full charging C4 that brought the cell back to the fully charged state FC4, i.e., the sum of C2 and C3. In other words, the net discharged amount, i.e., the net discharged capacity following fully charged state FC2=D2+D3+D4−C2−C3. This is represented in FIG. 2 at 204.

It is noted that RCE analyses can be performed in connection with the partial charging cycles PC1 and PC2 during the adding of the respective charges C2 and C3 even though the cell is not fully charged during these cycles. For example, during the charging that imparts charge C2 and expressing RCE as a percentage, RCE=100*C2/D2. Because the cell is not fully charged in this example, the lower threshold of the normality range (e.g., 98% per the example above) cannot be used. However, the upper limit of the normality range (e.g., 102% in the example above) can still be applied during this charging to ensure that overcharging does not occur (here it has not, as the RCE at PC1 is clearly well below even 100%). Similarly, during the charging that imparts charge C3 RCE=100*C3/(D2+D3−C2), and the resulting value can be compared to the upper limit (e.g., 102%) to determine whether or not overcharging is occurring (here, too, it has clearly not). When the cell is fully charged (here, to C4 at fully charged state FC3), the upper limit (e.g., 102%) can be used during the charge process while the lower threshold (e.g., 98%) can be used at the end of charging.

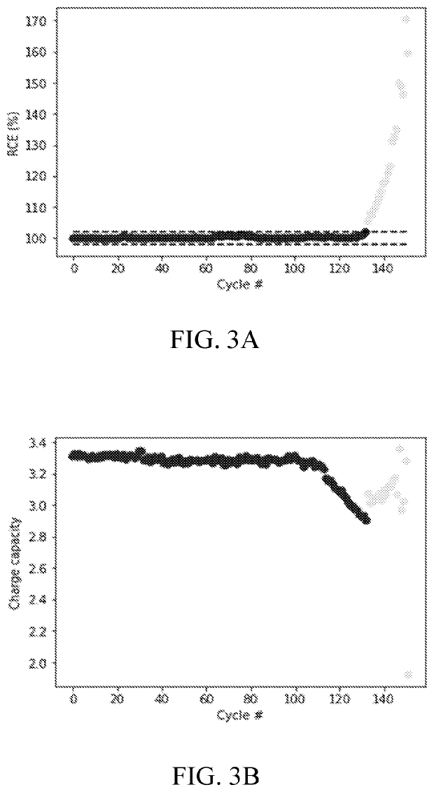

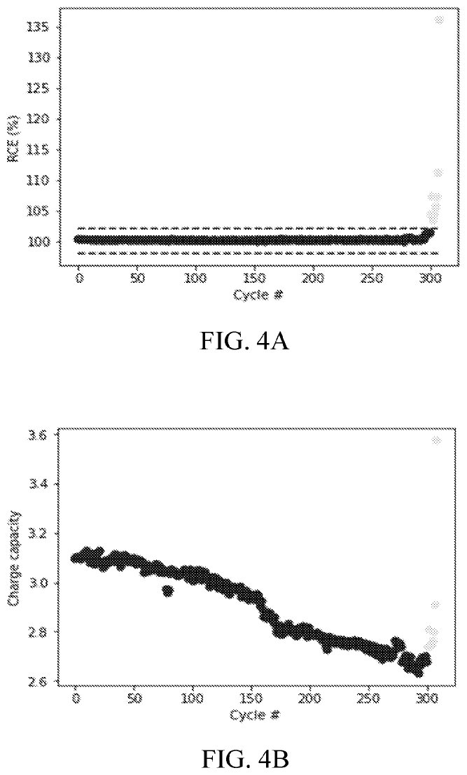

FIGS. 3A through 4B show example results using the RCE health index for early anomaly detection in three differing test secondary electrochemical cells. FIGS. 3A, 3B, 4A, and 4B are directed to anomalies, such as dendrites, that caused values of the RCE health index to exceed a maximum acceptable RCE limit in later charging cycles. The cell anomalies in these two cases (FIGS. 3A and 3B on the one hand and FIGS. 4A and 4B on the other) cannot be detected or, at most, only detected at the last cycle using the traditional definition of overcharge, discussed above. However, using the new RCE health index, the cell anomaly was detected multiple cycles before effects of the anomaly, such as overheating, thermal runaway, and/or explosion, become apparent. By using the RCE health index as a control in battery-testing cycler software, cell testing can be stopped once the anomalous cell behavior is detected. The RCE health index can also, for example, be incorporated into a battery management system (BMS), a battery charger, or other system that utilizes charging circuitry for charging a cell.

FIGS. 3A and 3B show results of charging a first test cell over about 150 charge-discharge cycles. As with FIG. 1, the normality window (illustrated by dashed lines in FIG. 3A) of the RCE health index was defined as 100%+/−2% as determined from prior testing and statistical analysis. Thus, as long as the value of the RCE health index after a full charging remained within this normality window, the first test cell was deemed to be healthy and operating normally. As can be seen in FIG. 3A, at about charging cycle number 134 the RCE value determined by charging circuitry (not shown) was about 102%, which is the upper limit of the normality window. On the next charging cycle, i.e., charging cycle number 135, the RCE value was above 102%, at about 105%. Had the testing system been implementing an RCE-based method of controlling the charging circuitry, the fact that the RCE value of 105% exceeded the upper limit of the normality window of 102% could have been used to shut down the charging circuit at the moment when RCE exceeded 102%, to keep it from providing any more charge to the first test cell. However, since controlling charging was not a goal of the testing of the first test cell, discharge-charge cycles continued, with the RCE values continuing to climb (FIG. 3A) and the actual overall charge capacity becoming erratic (FIG. 3B) after a significant but linear decline that started around cycle number 110. As can be seen by comparing FIGS. 3A and 3B with one another, the RCE values remained very close to 100% up to about cycle number 134 even though the actual overall charge capacity started declining significantly around cycle number 110. This suggests that the deterioration of the first test cell was organic until cycle 134.

FIGS. 4A and 4B show results of cycling a second test cell over about 310 charge-discharge cycles. Here, too, like with FIGS. 2, 3A, and 3B, the normality window (illustrated by dashed lines in FIG. 4A) of the RCE health index was defined as 100%+1-2% as determined from prior testing and statistical analysis. Thus, as long as the value of the RCE health index after a full charging remained within this normality window, the second test cell was deemed to be healthy and operating normally. As can be seen in FIG. 4A, the RCE values remained almost exactly 100% up to about cycle number 290, and this is so despite the actual overall charge capacity (FIG. 4B) gradually diminishing from before cycle number 50. In this example, the RCE values for this second test cell did not exceed the upper limit of the normality window, i.e., 102%, until about cycle number 301, where the RCE value was about 103%. From about cycle number 301 to the last charging cycle of about 310, the RCE values (FIG. 4A) continued to increase. Correspondingly, the actual overall charge capacities (FIG. 4B) also continued to increase. Here, too, if the RCE values and normality window upper limit were being used to control charging circuitry, the fact that the RCE value of 103% at cycle number 301 exceeded the upper limit (102%) of the normality window could have been used to cause the charging circuitry (not shown) to stop adding charge to the second test cell.

Depending on the permissible lower limit of RCE for acceptable performance, the fact that the end-of-charge RCE values decline in later cycle numbers can be used for any of a variety of purposes, such as to signal to an automated system and/or a human user that the third test cell has experienced an anomaly. For example, if a normality window is established (e.g., 100%+/−1%, 100%+1%/−2%, etc.), the end-of-charge RCE value at a current charge cycle can be compared to the corresponding lower limit (e.g., 99% or 98%, respectively in the two preceding examples) to determine whether or not to take action.

Example Methods and Systems

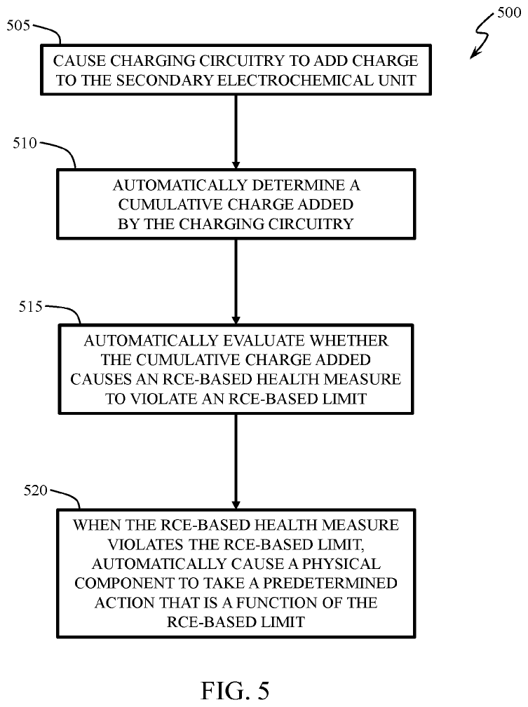

FIG. 5 illustrates an RCE-based method 500 of managing a secondary electrochemical unit (e.g., a secondary cell or secondary battery). At block 505, at the beginning of a current charging cycle, charging circuitry is caused to add charge to the secondary electrochemical unit. This may be done in any manner known in the art, such as by using a charge-initiation signal, generated by software, that effectively turns on charging circuitry. Regarding charging circuitry, the charging circuitry may be of any type known in the art. For example, the charging circuitry may be of a CC type, a CV type, a CC/CV type, a multistage CC (MCC) type, or a pulse type, among others. The charging circuitry may be under either software or hardware control, or combination of software and hardware control, for causing the charging circuitry to add charge to the secondary electrochemical unit. Once charging has been initiated, the charging circuit continues to add charge to the secondary electrochemical cell during the current charging cycle, in which the cell may be partially charged or fully charged. A cell is considered fully-charged when SOC=100%, which can be achieved by CV charging with a sufficiently low cutoff current, or by other types of charging circuitry that can accurately estimate the SOC, as known in the art. In the terminology of RCE, a new cycle starts right after a cell is fully charged, after which the net charge and discharge capacities are reset to 0.

At block 510, a cumulative charge that the charging circuit is adding to the secondary electrochemical unit during the current charging cycle is determined. The cumulative charge added during the current charging cycle can be determined in any suitable manner known in the art. Means, including circuitry, for determining the cumulative charge added during a charging cycle, such as coulomb counting, among others, are well known for each type of charging scheme employed. Details of such means are not required for one of ordinary skill in the art to practice the present invention to its fullest scope, since such an artisan could simply select an appropriate cumulative-charge-determining means or even design one as needed without any undue experimentation.

At block 515, it is automatically evaluated whether or not the cumulative charge added by the charging circuit during the current charging cycle causes an RCE-based health measure to violate (e.g., be greater than, be less than, fall outside a range of, or otherwise not meet) an RCE-based limit. The cumulative charge added is related to the RCE-based health measure and the RCE-based limit, because, by virtue of the nature of RCE, it is the cumulative charge added that underpins both the RCE-based health measure and corresponding RCE-based limit. In some cases, the RCE-based health measure will be an end-of-charge RCE-based health measure, such as an end-of-charge RCE value, while in some cases the RCE-based health measure will be an RCE-based health measure, such as a real-time RCE value not determined at the normal conclusion of the current charging cycle, such as can happen in an overcharging situation when that real-time RCE value exceeds an overcharge shutoff limit (here, the upper limit of the RCE normality window). Following are some detailed examples of forms that the RCE-based health measure and the RCE-based limit may take.

As alluded to above, both the RCE-based health measure and the RCE-based limit can take any of a variety of forms, and the way that a violation can occur can vary depending on application at issue. However, a common underpinning of each of the RCE-based health measure and RCE-based limit is that they are based on the fundamental principle that, for a healthy secondary electrochemical unit, the amount of charge added back into the secondary electrochemical unit during a current charging cycle should be substantially equal to the net amount of charge discharged from the secondary electrochemical cell in the period between the most recent fully charged state and the current fully charging cycle. Consequently, the term “RCE-based” and like terms as used herein and in the appended claims denote this fundamental principle rather than any particular form, such as the percentage form discussed above for the RCE health index. Some example forms of the RCE-based health measure and RCE-based limit are presented below. However, those skilled in the art will understand that these examples are presented to illustrate variability and not to limit the possibilities. To the contrary, those skilled in the art may indeed be able to devise RCE-based health measures and RCE-based limits other than those shown in the examples.

As just noted, the RCE-based health measure is based on the fundamental principle that the amount of charge to fully recharge a secondary electrochemical unit should be substantially equal to the net charge discharged from the unit since the most recent full charge. The RCE-based health measure may be a current cumulative charge added (e.g., expressed as an actual charge value or as a %-age of the net discharged amount) or the output of one or more filters (e.g., short-term average, long-term average) applied to a series of RCE-based health measures collected over multiple charging cycles or any combination of the outputs of two or more filters (e.g., ratio, difference, etc.).

The corresponding RCE-based limit for the chosen form of the RCE-based health measure can take the same form as the RCE-based health measure, and the value(s) of the RCE-based limit may be set using any suitable criteria. In examples presented above in connection with FIGS. 1, 3A, 4A, and 5, the RCE-based health measure is in the form of the RCE health index itself expressed as a percentage of the net discharged amount. Correspondingly, those examples use a “normality window”, or “RCE normality window”, for defining an acceptable range of RCE-based health measure values and, consequently, for defining one or more RCE-based limits. For example, relative to those examples, the upper limit of the normality window is 102% and the lower limit of the normality window is 98% (i.e., 100%+1-2%). Here, either or both of 102% and 98% can be set as an RCE-based limit. For example, if a cumulative charge added as determined at block 510, expressed as a percentage of the corresponding net discharge, exceeds the 102% upper limit of the example normality window, then this violation of the RCE-based limit would be determined during the evaluation at block 515. As another example, if the cumulative charge added as determined at block 510, again expressed as a percentage of the corresponding net discharge, never reaches the 98% lower limit of the example normality window, then this violation of the RCE-based limit would be determined during the evaluation at block 515. Of course, the percentage expressions can be eliminated altogether. For example, instead of percentages, the direct ratios of cumulative charge added to net discharged amount can be used instead. In the above example, the upper and lower limits of the normality window would be replaced by 1.02 and 0.98, respectively.

It is emphasized that the 102% and 98% values for an RCE-based limit are merely examples and are not limiting. The actual value(s) for the RCE-based limit will typically vary according to any one or more of a variety of factors, including, but not limited to, the particular chemistry of the secondary electrochemical unit at issue. As indicated above, the value(s) for the RCE-based limit can be determined by testing one or more sets of test units, performing suitable statistical analysis of results of such testing, and selecting one or more values from the results of the statistical analysis for the RCE-based limit. The specific choice of the RCE-based limit depends on the acceptable compromise between detection rate and false alarm rate, for example, as discussed above in connection with FIG. 1B. A lower shutoff limit can detect more anomalous cells (higher detection rate) but at the price of possibly mislabeling some normal cells (higher false alarm rate). For high-risk cases such as in EV applications, a narrower normal range of RCE, e.g., 99%-101%, could be used to enhance safety. For low-risk cases such as testing of low-capacity cells in laboratories, a wider normal range of RCE, e.g., 96%-104%, could be used to generate more data for analysis.

In this first example, both the RCE-based health measure and the RCE-based limit are in the form of percentages. However, other forms of the RCE-based health measure and the RCE-based limit that are based directly on the cumulative charge added determined at step 510 can be used. For example, the cumulative charge added as determined at step 510 can be compared directly to the net discharge. In an example using the normality window of 100%+/−2% as expressed above and using a net discharged value of 500 milliamp-hours (mAh), the upper limit of the normality window would be 510 mAh ((500+0.02(500)) mAh) and the lower limit of the normality window would be 490 mAh ((500−0.02(500)) mAh), and either or both of these values could be used as a corresponding RCE-based limit. In this case, the cumulative charges themselves would be evaluated directly against the corresponding net discharge.

As another example, each cumulative charge added can be subtracted from the relevant net discharge, or vice versa, prior to evaluation at step 515. In these cases, the differences could be compared to, for example, upper and/or lower limits of a normality window that includes the value of zero, since in the ideal condition with a healthy secondary electrochemical cell the charge put back into a secondary electrochemical cell during a current charging cycle is equal to the net amount of charge discharge from the secondary electrochemical cell from the immediately previous fully charged state, meaning that the difference is zero. Using the 100%+/−2% example above, when using a difference between the cumulative charge added, the net discharge results in the limits being+(0.02×net discharge) and −(0.02×net discharge), with the signs used depending on which one of the cumulative charge added and the net discharged amount is subtracted from the other.

In some embodiments, the form of the RCE-based health measure and the RCE-based limit may be more complex. For example, the form may be based on applying one or more filters to timeseries data acquired over multiple recharging cycles. For example, any one of the forms discussed above for evaluating whether or not the RCE-based health measure violates the RCE-based limit can be used to generate a corresponding datapoint in each full-recharge charging cycle in which the method 500 is used. Over time and over multiple full-recharge charging cycles, the multiple individual datapoints will have accumulated as timeseries data. At each current charging cycle, this timeseries data, which can include a newly acquired datapoint from the current charging cycle, can be evaluated at step 515 (FIG. 5) using one or more statistical methods, expressed herein as “filters”. In such embodiments, the output(s) of the applied filter(s) as determined during the current charging cycle, or one or more functions of multiple filter outputs, is/are the RCE-based health measure, and one or more previously determined acceptable values of such output(s) or function(s) for the particular secondary electrochemical unit being recharged is/are the RCE-based charge-shutoff limit. Following is an example based on applying two filters, namely a short-term-moving-average (SMA) filter and a long-term-moving-average (LMA) filter, to timeseries data containing datapoints that are final values of the RCE health index calculated at each full-charge charging cycle. In this example, a function of the outputs of the SMA and LMA filters is the form of the RCE-based health measure and the RCE-based limit, and this function is referred to, herein and in the appended claims, as “difference in moving averages” (DMA).

In a sense, DMA can be considered a health index derived from the new RCE health index. DMA is based on a presupposition that values of the RCE health index for a healthy secondary electrochemical unit should be stable at around 100%. Consequently, a significant trend of RCE values deviating from 100% would indicate an evolving anomaly within the electrochemical unit, and such a trend can be used for early detection of the anomaly. In this example, the trend of RCE values collected over multiple full-charge charging cycles, including the current charging cycle, is analyzed using the technique of moving averages. More specifically, in this embodiment two moving averages are calculated, namely:

SMA=average of the most recent n end-of-charge RCE values; and

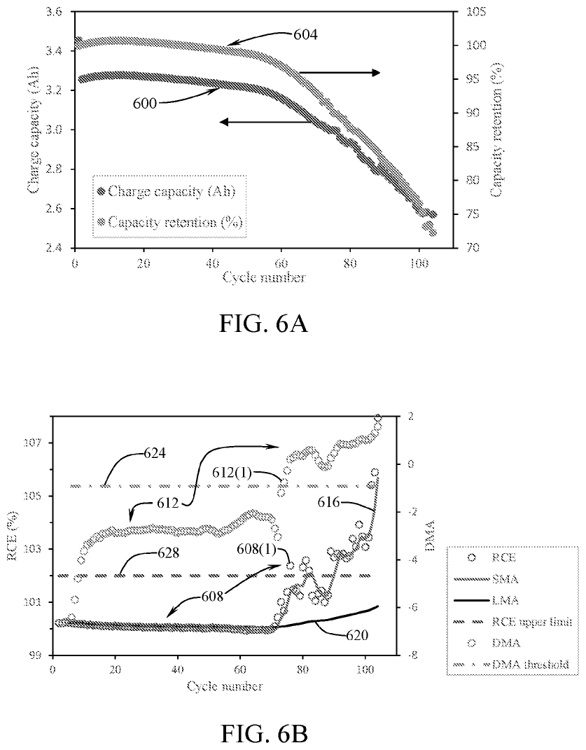

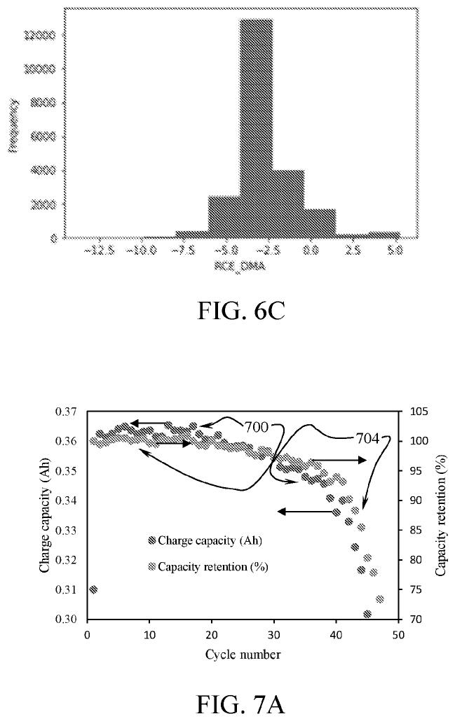

LMA=average of the most recent m end-of-charge RCE values,

wherein m>n. An example of DMA analysis is illustrated in connection with FIGS. 6A and 6B using n=4 and m=all cycles up to the current cycle. In some embodiments, the value of n should be small enough that the SMA can respond rapidly to change in the RCE values while at the same time not being so small that the SMA signal is noisy. For in, in some embodiments, its value should be large enough that the response of the LMA to change in RCE values is significantly slower than the SMA. Generally, any combination of m and n will work. However, it may take a routine trial-and-error approach to determine the most appropriate values for a particular application.

Referring to FIGS. 6A and 6B, FIG. 6A shows each of the charge capacity (effectively, curve 600 defined by individual cycle datapoints) and the capacity retention (effectively, curve 604 defined by individual cycle datapoints) versus cycle number for a particular test secondary cell. As can be seen in FIG. 6A, both the charge capacity and capacity retention declined relatively slowly at roughly the same rate up to about cycle number 60, after which both declined at much greater rates that are slightly different from one another. Compared to FIGS. 3B and 4B, the charge capacity of the test cell of FIG. 6A shows only normal degradation, which cannot be used to detect an anomaly. However, this test cell eventually exploded during rest after the discharge of cycle number 104.

FIG. 6B shows both end-of-charging RCE values 608 and the corresponding DMA values 612 for the test cell of FIG. 6A. As seen in FIG. 6B, both the SMA curve 616 and LMA curve 620 follow the trend of the end-of-charge RCE values 608. However, there is a difference between the response rates of the SMA and LMA. As illustrated by SMA curve 616, the SMA responds more rapidly to change in the end-of-charge RCE values 608, while the LMA curve 620 clearly displays a significant delay in the response of the LMA. When the end-of-charge RCE values 608 are stable around 100% (up to about cycle number 71), there is basically no difference between the SMA and the LMA. Once the end-of-charge RCE values 608 show a significant trend diverging from 100%, the differences between the SMA and the LMA become larger. These differences between the SMA and the LMA can be used to identify presence of trends in the end-of-charge RCE values 608, and such trends can be used as signals for anomaly evolution. Early detection is very important, as the secondary electrochemical unit could explode any time once a short circuit forms. Indeed, as noted above, the test cell exploded after discharging at cycle number 104. It could also allow for taking action to stop the anomaly from developing further, such as by shutting down the charging circuitry.

In this example of FIG. 6B, the following definition of DMA is used:

DMA=ln(abs(LMA−SMA)) (2)

For the particular cell design at issue, the DMA threshold 624 was determined to be −0.911 by analyzing the statistical distribution of DMA values collected from testing of 121 secondary cells. This distribution is shown in FIG. 6C. In this example, a secondary cell, e.g., the secondary cell corresponding to the data in FIGS. 6A and 6B, was determined to contain an anomaly when a currently determined value of DMA (i.e., the RCE-based health measure) was greater than −0.911, which in the example of FIG. 6B occurred around cycle number 74.

In the example of FIG. 6B, this DMA approach detected the relevant anomaly two cycles earlier than using an upper limit of a normality window, here 102% as represented in FIG. 6B by RCE upper limit 628, based on the RCE health index. This is seen in FIG. 6B by comparing with one another the cycle number at which the first DMA value 612 exceeds the DMA threshold 624 and the cycle number at which the first end-of-charge RCE value 608 exceeds the RCE upper limit 628. In this example, the first DMA value 612, here, value 612(1) to exceed the DMA threshold 624 occurred at cycle number 74, which is two complete cycles earlier than the cycle number 76 at which the first end-of-charge RCE value 608, here, value 608(1) exceeded the RCE upper limit 628. Even though the capacity retention at cycle number 76 was 89.8% and the capacity retention appeared normal, the DMA analysis easily detected an anomaly that eventually led to the catastrophic explosion of the test cell.

As illustrated by FIG. 6B, if DMA analysis were used as the form of the RCE-based health measure and the corresponding DMA threshold 624 were used as the RCE-based limit in the method 500 of FIG. 5, then the method 500 would have shut down charging based on the currently calculated DMA value (i.e., the RCE-based health measure) violating the DMA threshold (i.e., the RCE-based limit) at cycle number 74—a full two cycles earlier than had the RCE upper limit 628 been used for the analysis of the corresponding end-of-charge RCE values 608.

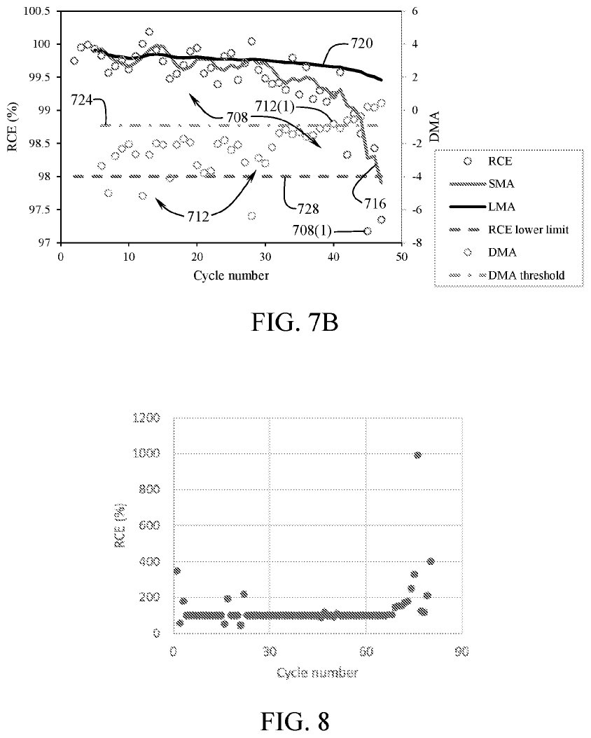

FIGS. 7A and 7B illustrate another example of implementing a DMA analysis scheme of the present disclosure. Like the example of FIGS. 6A and 6B, this example uses the same n and m values for SMA and LMA, respectively, as well as Equation 2 for determining DMA values. Referring to FIGS. 7A and 7B, FIG. 7A shows each of the charge capacity (effectively, curve 700 defined by individual cycle datapoints) and the capacity retention (effectively, curve 704 defined by individual cycle datapoints) versus cycle number for a particular test secondary cell. As can be seen in FIG. 7A, both the charge capacity and capacity retention declined relatively slowly at roughly the same rate up to about cycle number 40, after which both declined at much greater rates.

FIG. 7B shows both end-of-charging RCE values 708 and the corresponding DMA values 712 for the test cell of FIG. 7A. As seen in FIG. 7B, both the SMA curve 716 and LMA curve 720 follow the trend of the end-of-charge RCE values 708. However, there is a difference between the response rates of the SMA and LMA. As illustrated by SMA curve 716, the SMA responds more rapidly to change in the end-of-charge RCE values 708, while the LMA curve 720 clearly displays a significant delay in the response of the LMA. As can be readily seen, for this test cell the end-of-charge RCE values 708 were fairly unstable from the beginning of the cycle life and varied quite a bit relative to the target 100%.

As with the test cell of FIGS. 6A and 6B, the DMA threshold 724 (FIG. 7B) used for the test cell of FIGS. 7A and 7B was −0.911. However, rather than the test cell of FIGS. 7A and 7B having an anomaly that causes end-of-charge RCE values 708 to exceed an RCE upper limit of an RCE normality window as with the test cell of FIGS. 6A and 6B, the test cell of FIGS. 7A and 7B had an anomaly that implicated the RCE lower limit 728 of the normality window. In this example, the RCE lower limit implemented was 98%.

In the example of FIG. 7B, the DMA approach detected the relevant anomaly five cycles earlier than using the RCE lower limit 728 of 98%. This is seen in FIG. 7B by comparing with one another the cycle number at which the first DMA value 712 exceeds the DMA threshold 724 and the cycle number at which the first end-of-charge RCE value 708 falls below the RCE lower limit 728. In this example, the first DMA value 712, here, value 712(1), to exceed the DMA threshold 724 occurred at cycle number 40, which is five complete cycles earlier than the cycle number 45 at which the first end-of-charge RCE value 708, here, value 708(1), fell below the RCE lower limit 728.

Block 515 of FIG. 5 may also include automatically determining whether or not the secondary electrochemical unit has been fully charged to an SOC of 100%. As noted above, this can be done in any of a variety of ways depending on the charging regime implemented. Judging whether an electrochemical unit is fully charged is not only important to restarting RCE calculation, but also important for the application of the lower limit of the normality window of the RCE, as the lower limit is meaningful only when the electrochemical unit is fully charged.

Referring again to FIG. 5, at block 520 of the method 500, when the RCE-based health measure violates the RCE-based limit, a physical component is automatically caused to take a predetermined action that is a function of the RCE-based limit. The predetermined action can be any of a wide variety of actions. For example, the predetermined action may be shutting down charging of the secondary electrochemical unit, taking the electrochemical unit out of service, post a notification (such as a notification that the secondary electrochemical unit needs to be replaced, has been disabled, is unsafe, and/or has an anomaly, among others, and any combination thereof), initiate a healing mode, lower an upper cutoff voltage of the secondary electrochemical cell, modify cycling parameters of the secondary electrochemical cell, limit usage of the secondary electrochemical cell, flag the secondary electrochemical cell as having an anomaly, among others, and/or, when the secondary electrochemical unit is a cell within a multicell battery, redistributing loads to one or more other cells within the multicell battery, among others. Those skilled in the art will understand how to implement these actions based on knowledge in the art without undue experimentation.

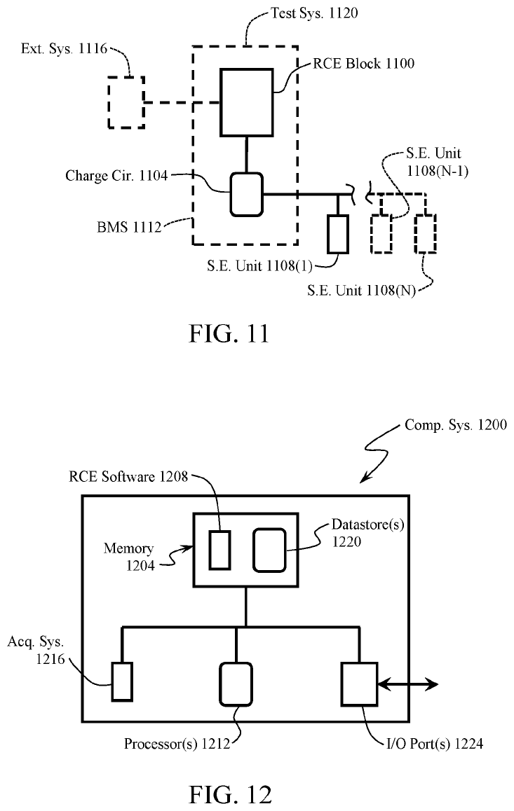

As those skilled in the art will readily appreciate, the physical component that is caused to take the predetermined action can vary significantly depending on the nature of the predetermined action and the physical system at issue. Examples of physical components that may be caused to take the predetermined action include, but are not limited to, charging circuitry (onboard and/or offboard the secondary electrochemical unit), a battery management system (BMS), overall device (e.g., EV) management system (DMS), a testing system, and/or a microprocessor aboard or otherwise part of the secondary electrochemical unit, a BMS, a DMS, a testing system, or another system, among others. Some of these examples of physical components that may be caused to take the predetermined action are illustrated in FIGS. 11 and 12, described below. Fundamentally, there is no limitation on the type of the physical component other than that it can be responsive to control based on the evaluation at block 515 and that it is capable of taking the requisite predetermined action. Those skilled in the art will readily be able to determine the physical component needing to be controlled to take the predetermined action based on the design of the system into which the secondary electrochemical unit is deployed or otherwise placed.

Regarding the predetermined action being a function of the RCE-based limit, those skilled in the art will readily appreciate that the type of predetermined action will vary as a function of the RCE-based limit and the application at issue. For example, if the RCE-based limit is being used for causing actions such as charging shutdown, notification of overcharging, and the like, then the RCE-based limit may be an upper limit, such as an upper limit of an RCE normality window or an upper limit on DMA. As another example, the action is to operate in a healing mode, then the RCE-based limit may be a healing RCE value that is lower than the upper limit of an RCE normality window. In a further example, if the action is to label the secondary electrochemical unit as having an anomaly and/or controlling the operation of the secondary electrochemical unit based on the anomaly, then the RCE-based limit may be a lower limit of an RCE normality window. Those skilled in the art will readily understand how to select the appropriate RCE-based limit and the corresponding predetermined action(s) that is/are a function of the RCE-based limit based on the particular application at issue.

Regarding anomalies that can be detected and identified using RCE-based techniques disclosed herein, it has been observed that most of the anomalous test cells have had RCE health index values greater than the 102% upper limit of the normality window due to formation of internal short circuit. However, the root cause of short circuit formation can vary. For example, visual inspection of a lithium-metal electrochemical cell, for which charging was stopped because the cumulative charge added exceeded the 102% (for that particular case) RCE-based limit, revealed that there was electrolyte leakage near the cathode tab area. The electrolyte leakage could have caused nonuniform lithium stripping/plating, which eventually lead to dendrite formation that caused the internal shorting.

FIG. 8 illustrates another example having a different failure mechanism. As can be seen in FIG. 8, the particular test electrochemical cell at issue experiences strong oscillation of RCE health index values at the early stages of cycling, with the RCE health index values eventually stabilizing until a later stage wherein the RCE health index values became much higher than 102%. It is believed that the initial oscillation implies existence of mechanical damage within the cell, which randomly blocked access to part of the cathode. A post-mortem analysis shows that five of the cathode tabs were broken, and there was dendrite formation visible from the side. It is believed that the mechanical damage caused nonuniform lithium stripping/plating, which eventually lead to dendrite formation that caused the internal shorting.

While the two immediately foregoing examples are of anomalous cells that experienced increasing trends of RCE health index values, some of the tested anomalous cells showed a decreasing trend of RCE health index values. An example is given in FIGS. 7A and 7B, discussed above. When RCE health index values remain significantly below 100% (e.g., at least 2% or more), that implies that the tested electrochemical cell cannot be recharged to the same immediately previous fully-charged state. In other words, the active metal (e.g., lithium) cannot be fully extracted from the cathode even at a low charge rate. This could be caused by mechanical damage, such as tab crack, electrode damage, gassing, or caused by electrolyte depletion, among other things. These examples demonstrate that RCE-based methods of the present disclosure are insensitive to the root cause of anomaly but are able to detect them.

As discussed above, the RCE health index and corresponding methods can be used for anomaly detection. For example, if the RCE health index is greater than, say, 102%, then the secondary electrochemical unit may be considered unacceptably anomalous and should not be cycled anymore. However, if this happens at the early stage of a cell, it will significantly reduce the cycle life of a secondary electrochemical unit. This will be highly undesirable in real-world applications even though it enhances safety, as it will increase the cost of the unit.

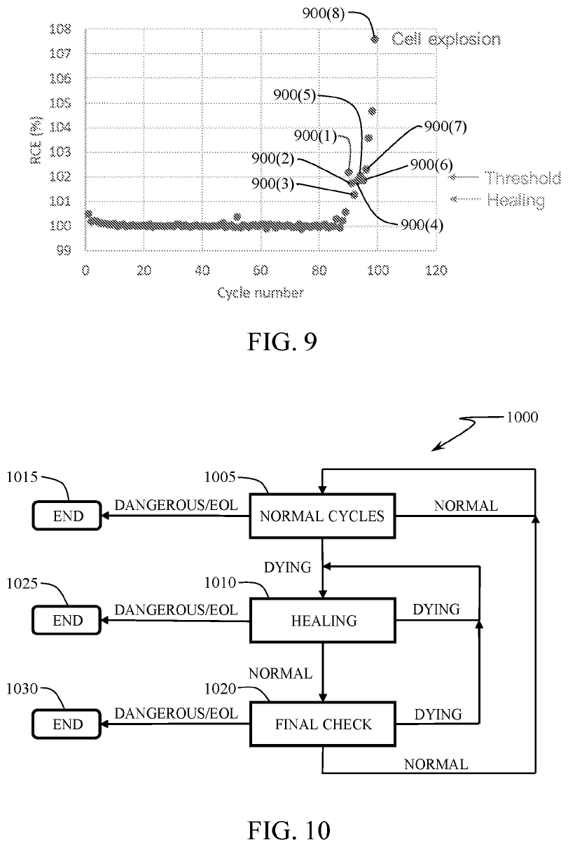

Instead of waiting for a secondary electrochemical unit to become severely damaged, an RCE-based method can use an early signal of anomaly development to intervene and prevent the anomaly from further developing. For example, FIG. 9 shows the evolution of the RCE health index for a cell that eventually exploded. As can be seen in the example of FIG. 9, the anomaly threshold (a/k/a the RCE-based charge-shutoff limit when used for controlling charging) was 102%, and the measured RCE health index value for this particular cell exceeded this anomaly threshold for the first time at cycle number 90 (datapoint 900(1)). However, for the next five cycles, i.e., datapoints 900(2) through 900(6), the measured RCE health index values reduced to a level at or below the 102% anomaly threshold. Then, at cycle number 96 (datapoint 900(7)), the measured RCE health index value again exceeded the 102% anomaly threshold, and further subsequent cycles display an exponential increase in the measured RCE health index values up to the point that the cell exploded (datapoint 900(8)).

Using an RCE-based methodology as discussed above, cell cycling could be stopped about 10 cycles before explosion. This is indicated by datapoint 900(1) where the measured RCE health index value first exceeded the anomaly threshold, where, had the 102% value been used as the RCE-based limit, the methodology would have stopped the charging process. However, as can be seen in FIG. 9, there was also an apparent trend of increasing measured RCE health index values in cycles leading up to cycle number 90 (datapoint 900(1)), which signaled that the anomaly became more severe over multiple cycles. This phenomenon may be leverageable to set a lower RCE-based healing threshold that can be used to shut off charging when the measured RCE-based health index values are starting to increase because of a developing anomaly. Because the RCE-based healing threshold is lower than the RCE-based charging shutdown limit, less charge is flowed into the cell, and this reduced amount of charge added can help with the healing process. In the present example, the RCE-based healing threshold was set at 101%, which is the starting point of a healing process that can, depending on the anomaly and its healability, cause the measured RCE-based health index values to become normal again, i.e., to be closer to 100%, in this case. The measured RCE-based health index values can also be used to determine when healing is completed. An example method 1000 of facilitating healing of a secondary electrochemical unit is shown in FIG. 10. In addition to using a lower RCE limit, other RCE-based features, e.g., DMA, can also be used for healing initiation.

FIGS. 6A and 6B can also be used to illustrate the potential for healing by employing a reduced RCE upper limit. Referring to FIGS. 6A and 6B and using 102% as the RCE upper limit 628, the cell cycling should be stopped at cycle 76, at which point the cell still has 89.8% of the initial capacity. With that level of remaining capacity, it would be a waste if the cell could not be used anymore. Looking at FIG. 6B, the end-of-charge RCE values 608 show a clear increasing trend starting at cycle 72, where the end-of-charge RCE value was 100.43%. If a healing RCE threshold is set to a value lower than the 102% upper limit, say to 101%, then the cell may be considered to be in a healing mode as long as the end-of-charge values 608 remain between the healing RCE threshold (here, 101%) and the RCE upper limit (here, 102%). In the example shown, the healing mode starts from cycle 75. If successful, the end-of-charge RCE values 608 may return to more normal levels close to 100% so that the cell could continue to be used without risk.

Referring to FIG. 10, and also to FIG. 9 and FIGS. 6A and 6B for example contexts as discussed immediately above, the method 1000 may include a block 1005 wherein the secondary electrochemical unit is experiencing normal cycles in which when charging proceeds to its normal conclusion (i.e., an RCE-based charging-shutdown limit is not implemented) and the RCE-based health measure remains below a predetermined RCE-based healing threshold, such as the 101% value noted above relative to FIG. 9. Normal charging cycling can proceed at block 1005 until the currently measured value of the RCE-based health measure exceeds the RCE-based healing threshold (again, e.g., 101%). When the currently measured value of the RCE-based healing measure exceeds the RCE-based healing threshold but the charging process reaches its normal conclusion with the measured value of the RCE-based health measure not exceeding the RCE-based charging-shutdown limit (e.g., 102% in the example of FIG. 9), then the secondary electrochemical unit may be flagged as dying, but potentially being healable. In this situation, the method 1000 may proceed to block 1010. However, when the currently measured value of the RCE-based healing measure exceeds the RCE-based healing threshold and the measured value of the RCE-based health measure exceeds the RCE-based charging-shutdown limit (again, e.g., 102%) without the charging reaching its normal conclusion, the fact that the currently measured value of the RCE-based health measure exceeds the RCE-based charging-shutdown limit may be used to stop the charging (block 1015) and optionally flagging the secondary electrochemical cell as being dangerous or at its end of life (EOL).

When the method 1000 proceeds to block 1010 at which the secondary electrochemical cell is in a healing, or potential healing, state, at block 1010 a process similar to some of the processes discussed above relative to block 1005 can be performed. For example, as long as the currently measured RCE-based health measure is above the RCE-based healing threshold but the charging process comes to its normal conclusion, then the method 1000 may deem the secondary electrochemical cell to continue to be in the dying/healing state. However, two other states can be determined at block 1010, namely, a return to normal state and a dangerous/EOL state. The method 1000 may determine that the secondary electrochemical unit has returned to a normal state at block 1010 when the charging process has concluded and the currently measured RCE-based health measure no longer exceeds the RCE-based healing threshold (e.g., 101%) and, optionally, is also not below an RCE-based healthy-unit lower limit (see, e.g., 98% as used in the 100%+/−2% normality window discussed above). When the block 1010 determines that the secondary electrochemical unit has returned to a normal state, the method 1000 may proceed to block 1020. Alternatively, the method 1000 may determine that the secondary electrochemical unit is dangerous or at EOL at block 1010. This can occur when the currently measured RCE-based health measure exceeds the RCE-based limit (e.g., 102%) when the charging process has not yet reached a natural conclusion, indicating that the charging process is continuing to add charge to an anomalous unit. When this happens, the example method 1000 proceeds to block 1025 at which the current charging cycle is ended and, optionally, the secondary electrochemical unit is identified as an anomalous unit.

When the method 1000 proceeds to block 1020 at which a final check may be performed, at block 1020 a process similar to some of the processes discussed above relative to block 1010 can be performed. For example, if at block 1020 it is determined that the secondary electrochemical unit remains in the normal state as determined at block 1010, then the method 1000 may proceed back to block 1005. However, two other states can be determined at block 1020, namely, a dying state and a dangerous/EOL state. The method 1000 may determine that the secondary electrochemical unit has returned to a dying state at block 1020 when the currently measured RCE-based health measure is above the RCE-based healing threshold but the charging process comes to its normal conclusion. When the block 1020 determines that the secondary electrochemical unit has returned to a dying state, the method 1000 may proceed back to block 1010. Alternatively, the method 1000 may determine that the secondary electrochemical unit is dangerous or at EOL at block 1020. This can occur when the currently measured RCE-based health measure exceeds the RCE-based limit (e.g., 102%) when the charging process has not yet reached a natural conclusion, indicating that the charging process is continuing to add charge to an anomalous unit. When this happens, the example method 1000 proceeds from block 1020 to block 1030 at which the current charging cycle is ended and, optionally, the secondary electrochemical unit is identified as an anomalous unit.

As one skilled in the art can appreciate from reading and understanding the foregoing disclosure, fundamental principles underlying the RCE health index disclosed herein can be implemented in a wide variety of forms, for a number of purposes, and in a variety of systems. FIG. 11 is an attempt to illustrate some of these. In this connection, it is noted that the RCE-based aspects of FIG. 11 are represented collectively by an “RCE block” 1100, which represents any combination of software and hardware, whether contained in a single computing device or distributed across multiple computing devices or other hardware, that performs the described functionality(ies). As noted above, the variety of applications for RCE-based functionality(ies) described herein are numerous and varied, and one skilled in the art will readily appreciate that it is impractical, as well as unnecessary, that every one of these be described in detail herein for a skilled artisan to understand how to implement RCE-based functionalities in such applications. To the contrary, those of ordinary skill in the art will readily understand from reading and understanding this entire disclosure how to implement RCE-based functionalities to their fullest scope in any software-hardware environment by applying routine techniques well known in the art.

In some embodiments, and as discussed above in connection with the method 500 of FIG. 5, RCE block 1100 may be deployed to control charging circuitry 1104 for charging one or more secondary electrochemical units 1108(1) to 1108(N), which, as noted above, can be any type of secondary electrochemical unit. In such applications, the RCE block 1100 may be configured to perform any one or more methods of the present disclosure, such as any of the methods described above in connection with FIGS. 1-5 and any of the methods described above in connection with FIGS. 6A-10. In some embodiments, the RCE block 1100 and the charging circuitry 1104 may be parts of a BMS 1112 that is located onboard or offboard a single battery (secondary electrochemical unit 1108(1)) or that is part of a larger system of batteries, such as used in electric vehicles, among many other applications, in which multiple individual batteries are controlled via a BMS common to all of the batteries. In some cases in which batteries are composed of multiple secondary cells, the RCE block 1100 may perform the RCE functionality(ies) on each secondary cell individually (since anomalies are cell-based) or on the battery as a unit. In the latter case, additional analysis may need to be performed to adjust any RCE-based limit(s) to account for the manner in which an individual cell anomaly impacts the overall battery. Those skilled in the art will readily be able to conduct such additional analysis in accordance with the configuration of a multicell battery. The charging circuitry 1104 may be any suitable charging circuitry for implementing a charging protocol suitable for the secondary electrochemical unit(s) 1108(1) to 1108(N), including, but not limited to the above-listed example CC, CV, CC/CV, MCC), or pulse charging protocols, among others.

In some embodiments, the BMS 1112 may be functioning in the field as deployed in connection with powering a real-world device (not shown) or portion thereof, such as an electric vehicle or a personal electronic device (e.g., smartphone, laptop, etc.), among many others too numerous to mention. Fundamentally, there is virtually no limit to the types of devices in which the BMS 1112 and corresponding secondary electrochemical unit(s) 1108(1) to 1108(N) can be fielded. When the BMS 1112 and the charging circuitry 1104 is fielded in a real-world application, the RCE block 1100 may be configured to catch anomalies early enough, such as to prevent overheating and/or explosion, and to control the charging circuitry accordingly to shutdown charging at an appropriate time, for example, in a manner described above in connection with method 500 of FIG. 5. The RCE block 1100 may also or alternatively be configured to implement a healing protocol, such as the healing protocol mentioned above in connection with method 1000 of FIG. 10, to attempt to heal one or more of the secondary electrochemical units 1108(1) to 1108(N) and to control the charging circuitry 1104 accordingly.

It is noted that while the RCE block 1100 and the charging circuitry 1104 are shown as being with the BMS 1112, this does not necessarily mean that they are present in the same hardware. In some embodiments, the RCE block 1100 and the charging circuitry 1104 may indeed by deployed in the same hardware as one another, which may be located onboard or offboard the secondary electrochemical unit(s) 1108(1) to 1108(N). However, in other embodiments, the RCE block 1100 and the charging circuitry 1104 may be deployed in separate hardware. For example, the charging circuitry 1104, or portion(s) thereof, may be located onboard each present secondary electrochemical unit 1108(1) to 1108(N), while the RCE block 1100, or portion(s) thereof, may be located offboard of each present secondary electrochemical unit, such as aboard a separate control module or other controller (not shown). Those skilled in the art will readily understand how to implement RCE block 1100 and charging circuitry for the relevant application.

In addition to controlling the charging circuitry 1104, the RCE block 1100 may provide other functionality, such as generating a flag or other identifier that identifies a status of each of one or more of the secondary electrochemical units 1108(1) to 1108(N) present. For example, when the RCE-based health measure of a current charge cycle is within a normality window, the RCE block 1100 may generate an identifier that indicates that the corresponding secondary electrochemical unit is functioning normally (i.e., is healthy). As another example, when the RCE-based health measure of a current charge cycle is outside a normality window, the RCE block 1100 may generate an identifier that indicates that the corresponding secondary electrochemical unit 1108(1) is not functioning normally (i.e., is anomalous and not healthy). In this case, the RCE block 1100 may also take the affected secondary electrochemical unit(s) 1108(1) to 1108(N) out of service. As a further example, when the RCE-based health measure of a current charge cycle is within a healing window, the RCE block 1100 may generate an identifier that indicates that the corresponding secondary electrochemical unit 1108(1) to 1108(N) is in a healing state and/or that further attention should be paid to such unit(s). Information that the RCE block 1100 generates may be sent to an external system 1116, such as a higher-level controller, for example, a power-management controller, among others.

In some embodiments, the RCE block 1100 and charging circuitry 1104 may be implemented in a testing system 1120. Depending on the purpose and/or configuration of the testing system 1120, the RCE block 1100 may be configured to either control the charging circuitry 1104 in a manner that conducts the testing safely (e.g., to prevent overheating and/or explosion) or to determine values of one or more RCE-based health measures during all test conditions up to and perhaps including overheating and/or explosion or other catastrophic failure (e.g., to fully characterize each of the secondary electrochemical unit(s) 1108(1) to 1108(N) and/or to collect data for statistical analysis for determining RCE-based parameters, such as normality windows, RCE-based limits, and healing thresholds, among other things. As noted above relative to BMS implementations, in a testing deployment the RCE block 1100 may be configured to provide one or more flags or other identifiers or information to the external system 1116, which may be a higher-level testing controller, a remote computing system (e.g., an application server, web server, etc.) for collection and storing and/or displaying to one or more users involved with the testing.

It is noted that any RCE-based functionality(ies) deployed via the RCE block 1100, regardless of whether deployed for real-world charging control or testing, can be in addition to, or in lieu of, deployment of any other anomaly detection schemes desired to be employed.

As discussed above, any one or more of the foregoing functionalities can be incorporated into various types of apparatuses and systems, including apparatuses and/or systems for charging one or more secondary electrochemical units, apparatuses and/or systems for testing one or more secondary electrochemical units, and apparatuses and/or systems for managing battery operations and/or functioning within a larger system. At a high-level, methodology(ies) providing such functionality(ies) may be executed using suitable software and hardware implementing the software. For example, FIG. 12 illustrates an example scenario in which the hardware includes a computing system 1200 that includes memory 1204 containing suitable RCE-based software 1208 and one or more processors 1212 for executing the RCE-based software and/or other software needed to provide a fully functioning computing system as known in the art.

The memory 1204 may be any one or more types of hardware memory, including, but not limited to long-term storage memory(ies) (e.g., solid-state drives, optical drives, magnetic drives, etc.) and short-term storage memory(ies) (e.g., RAM, cache, BIOS memory, etc.) and any combination thereof. Fundamentally, there is no limitation on the type(s) of memory(ies) composing the memory 1204 used as long as the requisite functionality of the apparatuses and/or systems is achieved. For the purposes of the appended claims, the term “machine-readable storage medium” is used to describe memory 1204 to the exclusion of any transitory medium, such as a signal-encoded carrier wave. Each of the one or more processors 1212 may be of any suitable type, including but not limited to, general purpose microprocessors, application-specific integrated circuit processors, programmable array microprocessors, and system-on-chip microprocessors, among others, and any combination thereof. Fundamentally, there is no limitation on the type of processor(s) 1212 used as long as the requisite functionality of the apparatuses and/or systems is achieved.

The computing system 1200 may also include a charging parameter acquisition system 1216, for example, composed of any suitable software and/or hardware components, configured to acquire some or all of the charging parameters needed to continually determine the amount of charging being added to each of one or more secondary electrochemical units (not shown, but see, e.g., secondary electrochemical units 1108(1) to 1108(N) of FIG. 11) during a charging cycle. Examples of hardware (not shown) for the charging-parameter acquisition system 1216 include circuitry and/or sensors in operative communication with charging circuitry and/or discharging circuitry, such as conventional charging and/or discharging circuitry. See, e.g., charging circuitry 1104 of FIG. 11. Such circuitry and/or sensors may be located in any suitable location relative to each secondary electrochemical unit at issue, such as internal to the secondary electrochemical unit, within a testing system for cycle testing but external to the secondary electrochemical unit, within an external charger and external to the secondary electrochemical unit, or within a BMS but external to the secondary electrochemical unit, among others. Correspondingly, the charging parameter acquisition system 1216 may be located at any suitable location within an apparatus or system, such as internal to a secondary electrochemical unit, within a testing system for cycle testing but external to the secondary electrochemical unit, within an external charger and external to the secondary electrochemical unit, or within a BMS but external to the secondary electrochemical unit, among others.

The memory 1204 may contain one or more datastore(s) 1220 containing data and/or other information needed to perform the requisite RCE-based functionality(ies) enabled by the RCE-based software 1208. For example, the datastore(s) 1220 may contain various parameters for the RCE-based functionality(ies), such as normality window(s), RCE-based charge-shutoff limit(s), and healing thresholds, among other. The datastore(s) 1220 may contain, for each secondary electrochemical unit for which the RCE-based software is used, charging and/or discharging data collected in prior charging and/or discharging cycles. For example, such data may include SOC values and/or RCE-based health measure values from prior charging cycles. If the RCE-based software 1208 is configured for use with multiple secondary electrochemical units, the datastore(s) may also include, among other information, information that uniquely identifies each particular secondary electrochemical unit, for example, for use in retrieving data and information specific to each secondary electrochemical unit. As those skilled in the art will readily appreciate, the RCE-based software 1208 is configured to retrieve and/or utilize information from the datastore(s) 1220 and the charging parameter acquisition system 1216 for using in performing the desired RCE-based functionality(ies).

The example computing system 1200 may also include one or more input/output (I/O) ports 1224 under operative control of the processor(s) 1212 and for communicating with all devices external to the computing system, including, but not limited to BMS(s), testing hardware, secondary electrochemical unit(s) (see, e.g., the secondary electrochemical units 1108(1) to 1108(N) of FIG. 11), and external system(s) (see, e.g., the external system 1116 of FIG. 11), among other things. Each I/O port 1224 may be of any suitable wired or wireless type and operative under any suitable communications protocol. As those skilled in the art will readily appreciate, the example computing system 1200, when put into practice, will include other components, such as firmware, operating system, and/or other software, internal communications bus(es), power supply, etc., that are well known and ubiquitous such that they need not be described herein.

Those skilled in the art are familiar with conventional charging apparatuses and systems, testing apparatuses and systems, and/or battery management apparatuses and systems and, therefore, will readily understand how to implement the new RCE health index and related functionalities as described herein, including the uses thereof addressed in the claims appended hereto, wherein are incorporated herein as if they were first disclosed in this section.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A method of managing a secondary electrochemical unit, the method comprising:
at the beginning of a current charging cycle, causing charging circuitry to add charge to the secondary electrochemical unit;
automatically determining a cumulative charge added by the charging circuit during the current charging cycle;
automatically evaluating whether or not the cumulative charge added causes a reverse-coulombic-efficiency (RCE)-based health measure to violate an RCE-based limit; and
when the RCE-based health measure violates the RCE-based limit, automatically causing a physical component to take a predetermined action that is a function of the RCE-based limit.

2. The method of claim 1, wherein when the RCE-based health measure violates the RCE-based limit, automatically causing charging circuitry to stop adding charge to the secondary electrochemical unit.

3. (canceled)

4. The method of claim 1, wherein when the RCE-based health measure violates the RCE-based limit, automatically causing a battery management system to disable use of the secondary electrochemical unit.

5. (canceled)

6. The method of claim 1, wherein when the RCE-based health measure is less than the lower limit, automatically causing a microprocessor to flag the secondary electrochemical unit as having an anomaly.

7. (canceled)

8. (canceled)

9. (canceled)

10. The method of claim 1, wherein when the RCE-based health measure is outside of the normality window, causing a battery management system to change one or more cycling parameters of the secondary electrochemical unit.

11. (canceled)

12. (canceled)

13. (canceled)

14. (canceled)

15. (canceled)

16. (canceled)

17. The method of claim 1, wherein:
the RCE-based limit is an RCE normality window;
evaluating whether or not the cumulative charge added causes the RCE-based health measure to violate the RCE-based limit includes determining whether or not the RCE-based health measure is outside of the normality window; and
when the RCE-based health measure is outside of the normality window, causing a battery management system to limit usage of the secondary electrochemical unit.

18. (canceled)

19. (canceled)

20. The method of claim 1, wherein:
the RCE-based limit is an RCE normality window;
evaluating whether or not the cumulative charge added causes the RCE-based health measure to violate the RCE-based limit includes determining whether or not the RCE-based health measure is outside of the normality window; and
when the RCE-based health measure is outside of the normality window, causing a battery management system to change one or more cycling parameters of the secondary electrochemical unit.

21. (canceled)

22. (canceled)

23. (canceled)

24. (canceled)

25. (canceled)

26. (canceled)

27. (canceled)

28. The method of claim 1, wherein while the charging circuitry is adding charge to the secondary electrochemical unit during the current charging cycle, continually and automatically:
determining the cumulative charge added by the charging circuit; and
evaluating whether or not the cumulative charge added causes the RCE-based health measure to violate an RCE-based limit.

29. The method of claim 28, wherein when the RCE-based health measure violates the RCE-based limit, automatically causing the charging circuitry to stop adding charge to the secondary electrochemical unit.

30. The method of claim 28, wherein the RCE-based charge-shutoff limit comprises an RCE normality window, and the evaluating includes comparing a measure of the cumulative charge-added amount to the normality window.

31. The method of claim 28, wherein the RCE-based limit comprises an RCE normality-window upper limit that is equal to or greater than a net discharged amount of charge discharged from the secondary electrochemical unit since a full-charge charging cycle occurring most recently relative to the current charging cycle, and the evaluating includes comparing the measure of the cumulative charge-added amount to the RCE normality-window upper limit.

32. The method of claim 31, wherein the RCE normality-window upper limit is less than about 1.05 times the discharged amount.

33. The method of claim 31, wherein the RCE normality-window upper limit is in a range of greater than the discharged amount to less than about 1.05 times the discharged amount of charge.

34. (canceled)

35. (canceled)

36. (canceled)

37. (canceled)

38. (canceled)

39. The method of claim 1, further comprising evaluating whether or not the cumulative charge added causes the RCE-based health measure to violate an RCE-based healing threshold.

40. An apparatus or system, comprising:
memory containing machine-executable instructions for performing the method of claim 1; and
one or more processors in operative communication with the memory, wherein the one or more processors are configured to execute the computer-executable instructions so that the apparatus or system performs each method.

41. The apparatus or system of claim 40, further comprising a charging parameter acquisition system operatively configured to acquire one or more charging parameters during charging to allow the determining of the cumulative amount of charge added to the secondary electrochemical unit during the current charging cycle.

42. A computer-readable storage medium containing machine-executable instructions for performing the method of claim 1.

43. The method of claim 17, wherein the RCE-based health measure is an end-of-charge value, and the method further comprises automatically causing a battery management system to disable use of the secondary electrochemical unit.
